(19) United States
(12) Patent Application Publication
(10) Pub. No.: US 2004/0001933 A1
(43) Pub. Date: Jan. 1, 2004

(54) Floor mat and method for making the same

(76) Inventor: George Eberhard, Indianapolis, IN (US)

Correspondence Address: BARNES & THORNBURG, 11 SOUTH MERIDIAN, INDIANAPOLIS, IN, 46204

(21) Appl. No.: 10/185,564

(22) Filed: Jun. 27, 2002

(51) Int. Cl. B32B 3/10

(52) U.S. Cl. 428/46; 428/332

(57) ABSTRACT

A floor mat includes a top layer having indicia printed on a downwardly facing surface thereof. A bottom layer is adhesively secured to the top layer. A method of making a floor mat is also disclosed.

### BACKGROUND

This disclosure relates generally to a floor mat. More particularly, this disclosure relates to a floor mat having indicia printed thereon.

Floor mats are used to protect floors or other surfaces and/or to reduce fatigue of persons standing on the floor mats by providing cushion or padding. Some floor mats are decorated to improve the aesthetic appearance of the floor mat. Other floor mats include information to convey messages to users.

One known structure for a floor mat includes a top layer with decoration or information applied to an outer surface of the top layer. Such decoration or information, when printed with ink on the top surface, may become damaged or distorted over time through normal use.

Another known structure includes three layers in which a middle layer is sandwiched between a relatively clear top layer and a padded bottom layer. The middle layer has a top surface on which a color or decoration is provided. The middle layer is bonded to the relatively clear protective top layer and is further adhered to the cushioned bottom layer to provide padding. The color or decoration is visible through the clear top layer.

### SUMMARY

In one aspect of the present disclosure, a floor mat comprises a top layer and a resilient and compressible bottom layer secured to the top layer. The top layer includes an upwardly facing surface and a downwardly facing surface. The downwardly facing surface has indicia printed thereon and is positioned between the top and bottom layers.

In another aspect of the present disclosure, a floor mat comprises a top layer having an upwardly facing surface and an opposite downwardly facing surface. The downwardly facing surface has indicia printed thereon. The floor mat also comprises a bottom layer secured to the top layer. The bottom layer has an average thickness greater than an average thickness of the top layer. The bottom layer comprises a resilient and compressible material.

In yet another aspect of the present disclosure, a method of making a floor mat comprises the step of printing indicia on a downwardly facing surface of a translucent top layer. The method also comprises the step of securing a resilient and compressible bottom layer to the printed downwardly facing surface of the top layer.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a floor mat showing a top layer reverse printed on a downwardly facing surface thereof, and a bottom layer secured to the top layer;

FIG. 2 is a fragmentary perspective view of the floor mat of FIG. 1 showing the top layer peeled apart from the bottom layer thereby exposing a portion of adhesive that secures the top and bottom layers, a portion of the adhesive being removed to reveal an upper surface of the bottom layer;

FIG. 3 is a diagrammatic view of a printing press having multiple color stations for printing on the downwardly facing surface of the top layer of the floor mat;

FIG. 4 is an exploded perspective view of the floor mat of FIG. 1 showing the top layer, the bottom layer, and an adhesive between the layers and sandwiched between sheets of contact paper;

FIG. 5 is a perspective view of a partially assembled floor mat with indicia printed on the downwardly facing surface of the top layer, an upper surface of the bottom layer having adhesive applied thereto, a sheet of contact paper being peeled away to expose the adhesive to secure the bottom and top layers together; and

FIG. 6 is a side view of a portion of the bottom layer being compressed through application of a force by the foot of a user.

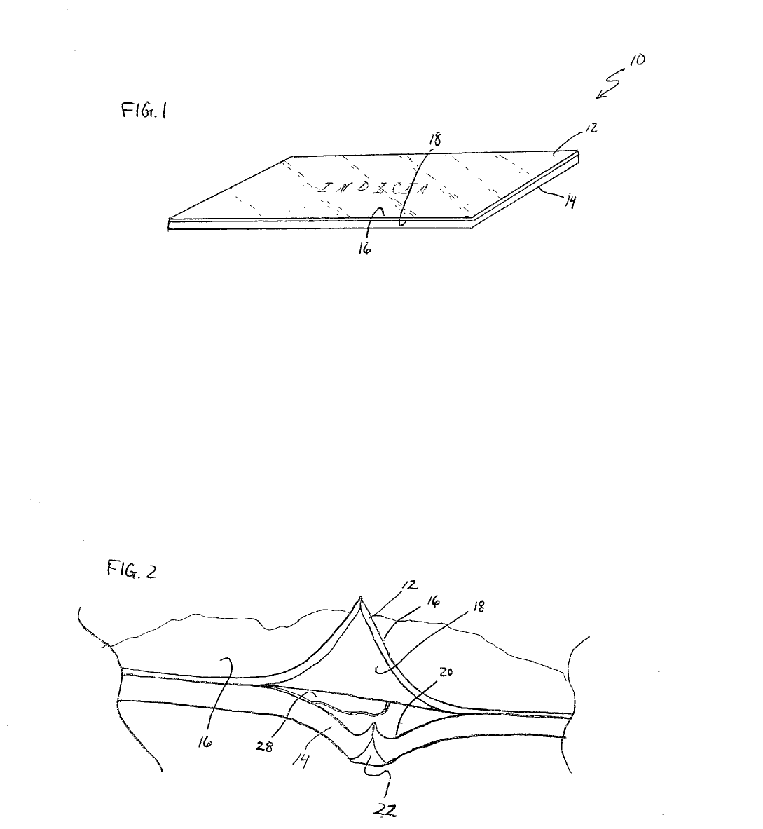

### DETAILED DESCRIPTION

As shown in FIG. 1, a floor mat 10 includes a top layer 12 and a bottom layer 14. Top layer 12 includes an upwardly facing surface 16 and a downwardly facing surface 18. Top layer 12 is a relatively clear, translucent, or transparent structure.

Bottom layer 14 is secured to top layer 12 using an adhesive or other suitable securement technique. Bottom layer 14 is constructed from a compressible and resilient material to provide cushion for floor mat 10. Bottom layer 14 includes an upper surface 20 and a lower surface 22 opposite the upper surface 20.

Indicia is reverse printed on downwardly facing surface 18 of top layer 12 so that it can be viewed by an observer looking through upwardly facing surface 16 of top layer 12. In such a reverse printing process, inks are printed on one surface and are viewed through another, generally opposite surface. What is meant herein by the term “indicia” is any advertisement, decoration, color, pattern, logo, information, textual or visual message, word, phrase, number, letter, symbol, or the like.

Top layer 12 is illustratively constructed of polycarbonate. Other materials that can be used to construct top layer 12 include, for example, polyvinyl chloride (PVC), polyethyleneterephthalateglycolate (PETG), acetate, and/or other materials and combinations thereof. Such materials preferably can be formed into a sheet and possess sufficient clarity or transparency to permit a user to view the indicia printed on downwardly facing surface 18 through upwardly facing surface 16.

The average thickness of top layer 12 can vary. Top layer 12 has an average thickness that possesses sufficient clarity, protects the indicia reverse printed on the downwardly facing surface 18, and withstands wear and tear of use. Some factors that may be relevant to the optimal thickness of top layer 12 include cost, processability (i.e., general handling, printing, cutting), clarity, durability, and the like. It is within the scope of this disclosure that top layer 12 has a thickness range of about 0.005 inch to about 0.2 inch. More narrow thickness ranges are also contemplated for use to balance various factors of a given floor mat design. One such exemplary range of thicknesses is the range from about 0.005 inch to about 0.01 inch. Another such exemplary range of thicknesses is the range from about 0.01 inch to about 0.1 inch. Other exemplary ranges of thickness ranges include the range from about 0.01 inch to about 0.03 inch and the range from about 0.1 inch to about 0.2 inch.

As shown in FIG. 6, bottom layer 14 is resilient and compressible to reduce fatigue of a user standing on the floor mat. Bottom layer 14 illustratively is constructed from a natural closed cell rubber or a latex. Bottom layer 14 can be constructed from other materials, such as other elastomers, including but not limited to synthetic rubber, a closed or open cell foam, or other materials. Preferably such materials have a thickness that permits compression of bottom layer 14 when a force is applied to floor mat 10 by a user, providing padding or cushion to the user.

The average thickness of bottom layer 14 can vary. An average thickness of from about ⅛ inch to more than 1 inch is believed to compress a sufficient amount to provide sufficient padding or cushion to reduce fatigue of a user standing on the floor mat. Depending on the demands of the application for which floor mat 10 is to be used, bottom layer 14 may provide light duty padding, medium duty padding, or heavy duty padding. As well as padding, other factors may influence the thickness of bottom layer 14. Some factors that may be relevant to the optimal thickness of bottom layer 14 include cost, processability (i.e. general handling, printing, cutting), durability, and the like. It is within the scope of this disclosure that bottom layer 14 has a thickness range of about ⅛ inch to about 1 inch. More narrow thickness ranges are also contemplated for use to balance various factors of a given floor mat design. One such exemplary range of thicknesses is the range from about ⅛ inch to about ¼ inch. Another such exemplary range of thicknesses is the range from about ¼ inch to about ½ inch. Yet another such exemplary range of thicknesses is the range from about ½ inch to about 1 inch.

Top layer 12 and bottom layer 14 are secured together, illustratively using an adhesive 28 bonded to the upper surface 20 of bottom layer 14. Adhesive 28 can be supplied in a solid form, such as the adhesive sheet shown in FIG. 4, or in a fluid form (not shown) that is applied onto a surface using methods such as, for example, brushing, spraying, or dripping. Adhesive 28 can be applied to one or both of top and bottom layers 12, 14. In an illustrative embodiment, adhesive 28 is first applied to bottom layer 14. Contact paper 30 is illustratively provided on adhesive 28 so that the adhesive is between bottom layer 14 and contact paper 30. Contact paper 30 is removed when top and bottom layers 12, 14 are ready to be secured to one another. When attached to adhesive 28, contact paper 30 prevents inadvertent sticking of adhesive 28 to an undesired object or in an unaligned position relative to top layer 12.

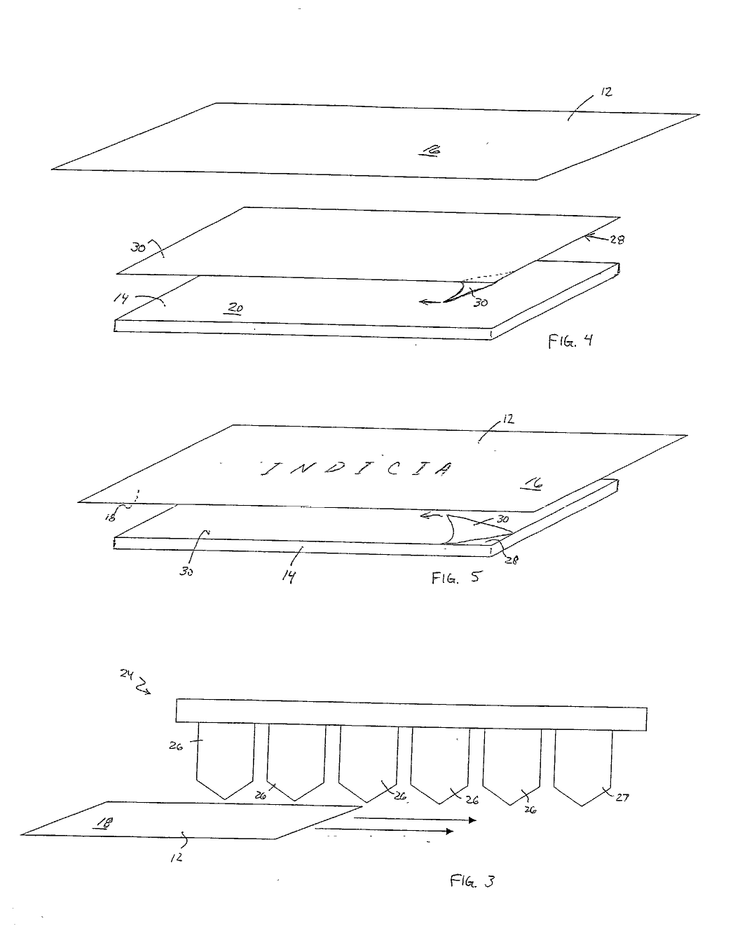

An exemplary method for making floor mat 10 begins with the reverse printing of indicia on downwardly facing surface 18 of top layer 12 using printing press 24. Printing press 24 has a plurality of color stations 26 used to print the indicia. In an exemplary arrangement, at least the final color station (color station 27 in FIG. 3) is used to print a trapping or other type of backing that is light in color, such as white. It is within the scope of this disclosure to utilize more than the last color station 27. To print such a trapping, for example, the last two or more such color stations could be used to print the trapping. Using a trapping limits reduction in the intensity and/or vibrancy of the color of the indicia, thereby limiting washing-out of the indicia. If desired, top layer 12 may be sent through printing press 24 a second time to print the trapping, for example, when all of the color stations are required to print a particular indicia in the first pass through printing press 24.

Bottom layer 14 is then aligned relative to top layer 12, and top layer 12 is advanced into contact with adhesive 28. Illustratively, pressure is applied to top layer 12 and bottom layer 14 to secure the layers together. It is within the scope of this disclosure to use an adhesive that is activated chemically, with heat, pressure, combinations thereof, and the like. Note that in the exemplary method described herein, adhesive 28 has previously been applied to upper surface 20 of bottom layer 14. However, if adhesive 28 is not “pre-applied,” adhesive 28 could be applied (e.g., brushed, sprayed, or dripped), as described further below, prior to securement of top layer 12 to bottom layer 14.

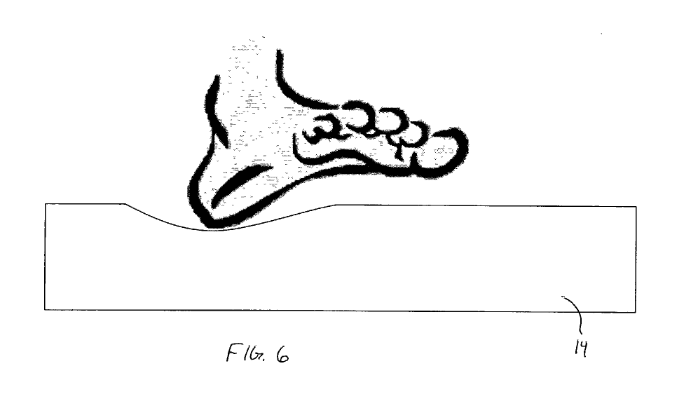

In one exemplary method, top layer 12 is provided having a size that is slightly larger than the final size the top layer 12 has when floor mat 10 is in its finished state. At least one edge of top layer 12 is sufficiently straight to provide a straight edge to align properly the top layer 12 in a die cutter (not shown). As shown in FIGS. 4 and 5, top layer 12 is sized larger than bottom layer 14 so that when the two layers are secured together, top layer 12 has a perimeter that extends beyond the bottom layer 14 in all directions. This assures that, even with some misalignment of the layers 12, 14, no portion of bottom layer 14 extends beyond at least the straight edge of top layer 12. Thus, an operator can place the straight edge of top layer 12 against a guide (not shown) of the die cutter to assist in accurate alignment of floor mat 10 in the die cutter. Using the die cutter, an operator then trims floor mat 10 to its final size as shown in FIG. 1.

It is within the scope of this disclosure to provide top layer 12 and/or bottom layer 14 in the form of roll stock or sheets, later trimmed to size before or after reverse printing, application of adhesive 28, and/or securing of the layers together.

In another exemplary process, a fluid or solid adhesive 28 is applied to the upper surface 20 of bottom layer 14 prior to the securement of layers 12, 14 to one another. Optionally, contact paper 30 is applied to the adhesive 28 before or after adhesive 28 is applied to bottom layer 14. As shown in FIG. 4, adhesive 28 may be formed into a sheet 32 having two pieces of contact paper 30 sandwiching the adhesive sheet 32 between them, which would necessitate removal of one of the pieces of contact paper 30 to expose the adhesive 28 and bond or otherwise secure it to the upper surface 20 of bottom layer 14. As shown in FIG. 5, after the adhesive 28 is applied to bottom layer 14 adhesive 28 is exposed by removal of contact paper 30. Top layer 12 is secured or adhered to bottom layer 14 by contacting top layer 14 with the exposed surface of adhesive 28. It is within the scope of this disclosure to apply or secure adhesive 28 to either one or both of the reverse printed downwardly facing surface of top layer 12 and the upper surface 20 of the bottom layer 14. It is also within the scope of this disclosure to provide bottom layer 14 with adhesive 28 already applied thereon. It is within the scope of this disclosure to eliminate one or both pieces of contact paper 30.

It is within the scope of this disclosure to alter the methods described herein by re-ordering certain of the steps of these methods. For example, the cutting of oversized top or bottom layers could be performed at any time.

Although the invention has been described in detail with reference to certain illustrative embodiments and steps, variations and modifications exist within the scope and spirit of the invention as described and defined in the following numbered claims.

1. A floor mat comprising:
a top layer, and
a bottom layer secured to the top layer, the top layer having an upwardly facing surface and a downwardly facing surface, the downwardly facing surface having indicia printed thereon, the indicia being positioned between the top layer and bottom layer.

2. The floor mat of claim 1, wherein an upper surface of the bottom layer and the printed downwardly facing surface of the top layer are adhesively secured to one another.

3. The floor mat of claim 1, wherein a trapping of printing ink is applied over the indicia.

4. The floor mat of claim 1, wherein the top layer comprises polycarbonate.

5. The floor mat of claim 1, wherein the bottom layer comprises an elastomer.

6. The floor mat of claim 5, wherein the elastomer is rubber.

7. The floor mat of claim 1, wherein the bottom layer comprises latex.

8. The floor mat of claim 1, wherein the top layer has an average thickness in a range from about 0.005 inch to about 0.2 inch.

9. The floor mat of claim 1, wherein the top layer has an average thickness in a range from about 0.005 inch to about 0.01 inch.

10. The floor mat of claim 1, wherein the top layer has an average thickness in a range from about 0.01 inch to about 0.1 inch.

11. The floor mat of claim 1, wherein the top layer has an average thickness in a range from about 0.01 inch to about 0.03 inch.

12. The floor mat of claim 1, wherein the top layer has an average thickness in a range from about 0.1 inch to about 0.2 inch.

13. The floor mat of claim 1, wherein the top layer has an average thickness of about 0.2 inch.

14. The floor mat of claim 1, wherein the bottom layer has an average thickness in a range from about ⅛ inch to about 1 inch.

15. The floor mat of claim 1, wherein the bottom layer has an average thickness in a range from about ⅛ inch to about ¼ inch.

16. The floor mat of claim 1, wherein the bottom layer has an average thickness in a range from about ¼ inch to about ½ inch.

17. The floor mat of claim 1, wherein the bottom layer has an average thickness in a range from about ½ inch to about 1 inch.

18. The floor mat of claim 1, wherein the bottom layer has an average thickness greater than the average thickness of the top layer.

19. A floor mat comprising:
a top layer having an upwardly facing surface and an opposite downwardly facing surface, the downwardly facing surface having indicia printed thereon, and
a bottom layer secured to the top layer, the bottom layer having an average thickness greater than an average thickness of the top layer.

20. The floor mat of claim 19, wherein the downwardly facing surface has at least one trapping of ink printed on the indicia.

21. The floor mat of claim 19, wherein the top layer and bottom layer are secured to one another with an adhesive.

22. The floor mat of claim 19, wherein the top layer comprises a material selected from the group consisting of polycarbonate, PETG, polyvinyl chloride, and acetate.

23. A method of making a floor mat comprising the steps of:
printing indicia on a downwardly facing surface of a translucent top layer, and
securing a bottom layer to the printed downwardly facing surface of the top layer.

24. The method of claim 23 wherein the step of securing the bottom layer to the printed downwardly facing surface of the top layer comprises securing adhesively the bottom layer to the printed downwardly facing surface of the top layer.

25. The method of claim 23, further comprising the step of printing a trapping on the indicia.

26. The method of claim 25, wherein the step of printing a trapping on the indicia comprises printing an ink trapping on the indicia.

27. The method of claim 23, further comprising the step of cutting at least one of the top layer and the bottom layer after securing the bottom layer to the printed downwardly facing surface of the top layer.
